(19) United States
(12) Patent Application Publication
(10) Pub. No.: US 2015/0286862 A1
(43) Pub. Date: Oct. 8, 2015

(54) Method for Statistically Aided Decision Making

(71) Applicant: Basware Corporation, Espoo (FI)

(72) Inventor: Antti NYMAN, Tampere (FI)

(21) Appl. No.: 14/674,105

(22) Filed: Mar. 31, 2015

(30) Foreign Application Priority Data
Apr. 7, 2014 (FI) FI20140100

(51) Int. Cl. G06K 9/00; G06K 9/62

(52) U.S. Cl. CPC G06K 9/00456; G06K 9/00483; G06K 9/00469; G06K 9/6202

(57) ABSTRACT

The invention concerns a computer executable method for facilitating a decision making process for a first document comprising a plurality of data components, each data component comprising at least one data field. The method is characterized in that it comprises computer executed steps of identifying from the first document at least one component for which a confidence rate is calculateable, for each identified data component, selecting a plurality of second documents that are associable with the first document based at least in part on the data content of the identified data component of the first document, for each identified data component of the first document, calculating a confidence rate utilizing the respective data components of the plurality of second documents, and initiating the decision making process for the first document wherein the process utilizes at least one of the calculated confidence rates.

### BACKGROUND

Some information management processes, e.g. document, e.g. invoice approval processes, need to be automated to enhance the efficiency of the process. The automation is based on the content of the document as well as knowledge about how to interpret the content.

The process automation in prior art systems has been implemented using some complex rule-based logic. The rules must typically be maintained by an administrator who may not be aware about all the small details that should have an effect on the rules. The complexity of the rules increases the amount of code executed by the computer as well as maintenance work required from administrators. The rules are typically able to handle majority of the transactions, but there are almost always some exceptional transactions that cannot be handled by the rules without making the rules and/or their maintenance process complex. Such transactions require manual processing. There may also be transactions, that do pass the rules of the automatic approval process, but the rules have been outdated because the rules administrator may not have all the information available required to maintain the rules. In such cases, there needs to be a feedback loop from manual approval process to the rules to keep the rules up-to-date using information obtained in the manual process.

There is a need to find a solution that facilitates efficient manual processing of documents which have not been successfully automatically processed e.g. by a rule-based solution. Advantageously, such solution should also improve the ability of the system to utilize the most recent knowledge about the various aspects of the document in the decision making process regarding the document.

### BRIEF DESCRIPTION OF THE INVENTION

An aspect of the present invention is a computer executable method for facilitating a decision making process for a first document comprising a plurality of data components, each data component comprising at least one data field. The method may be characterized in that it comprises computer executed steps for identifying from the first document at least one data component for which a confidence rate is calculateable, for each identified data component, selecting a plurality of second documents that are associable with the first document based at least in part on the data content of the identified data component of the first document, for each identified data component of the first document, calculating a confidence rate utilizing e.g. the respective data components of the plurality of second documents, and initiating a decision making process for the first document wherein the process utilizes at least one of the calculated confidence rates.

In an embodiment, the method may further comprises calculating a decision confidence rate for the entire document from the calculated component confidence rates.

In an embodiment, the step of initiating the decision making process may comprise rendering the calculated decision confidence rate of the entire document on a display device. The step of initiating the decision making process may also comprise executing an automatic decision for the document based on the value of the calculated decision confidence rate.

The method may further comprise the step of rendering at least one of the calculated component confidence rates on the display device of a terminal computer. Yet further, the method may further comprise the step of rendering at least one user interface control on the display device of the terminal computer for the purpose of detecting at least one user input event regarding at least one component confidence rate of the document.

The display device may be a touch sensitive display device.

The method may further comprise the step of storing in the memory of the computer the at least one user input event related to at least one calculated component confidence rate of the document. The user input event may comprise e.g. a new value for the component confidence rate or an process action associable with the component confidence rate.

The method may further comprise the step of storing the reached decision regarding the document and creating or updating, based on the decision and the content data of at least one document, at least one rule to automate the decision making process for future documents.

Any of the steps of the method disclosed herein may be executable by at least one computer comprising memory and at least one processor.

Another aspect of the invention is a non-transitory computer-readable storage medium having instructions stored thereon that, when executed by at least one processor, cause the at least one processor to function as a decision making system adapted to facilitate a decision making process regarding at least one document, the functioning comprising the steps of the method of an embodiment of the invention disclosed herein.

An aspect of the invention is a computer arrangement comprising any or any combination of the following computer implemented functional components:
statistics maintenance module for accumulating statistics about a plurality of data components of at least one document type,
automatic document processing unit for processing incoming documents e.g. using rules and providing input data for the statistics data maintenance module,
statistics data storage for storing statistic data related to the data components of the documents,
rules repository for storing rules usable by the incoming document processing unit,
decision data storage for storing the decision and optionally also opinion data related to the processed documents and/or their components,
rule maintenance module for maintaining rule data from the data of the statistic data storage, and
terminal device comprising an input device and an output device for providing user interface for manual decision and component characterization data.

Another aspect of the present invention is an arrangement comprising at least one computer, e.g. a terminal device and/or a server computer. The arrangement is adapted to comprise computer means for performing the steps of any of the methods disclosed herein.

### DRAWINGS

Some preferred embodiments of the invention are described below with references to accompanied figures, where:

FIG. 1 depicts an exemplary computer and networking arrangement usable in an embodiment of the present invention,

FIG. 2 presents a diagram of some functional and data elements of the present invention,

FIG. 3A shows a method according to an embodiment,

FIG. 3B shows a method according to an embodiment,

FIG. 4A shows a user interface according to an embodiment,

FIG. 4B shows a user interface according to an embodiment,

FIG. 4C shows a user interface according to an embodiment, and

FIG. 5 shows a high-level conceptual diagram of a computer device usable in various embodiments of the present invention.

### DETAILED DESCRIPTION OF THE INVENTION

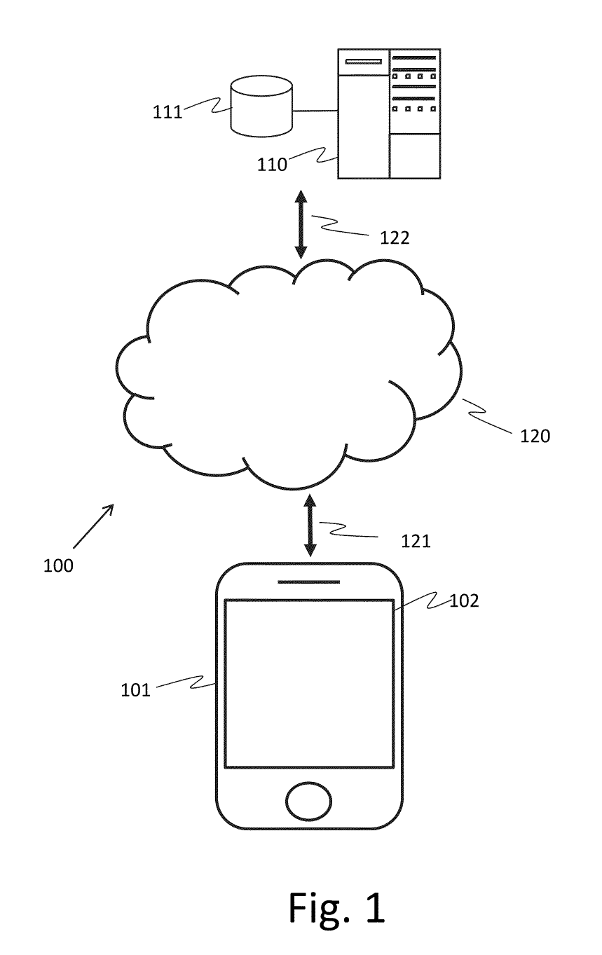

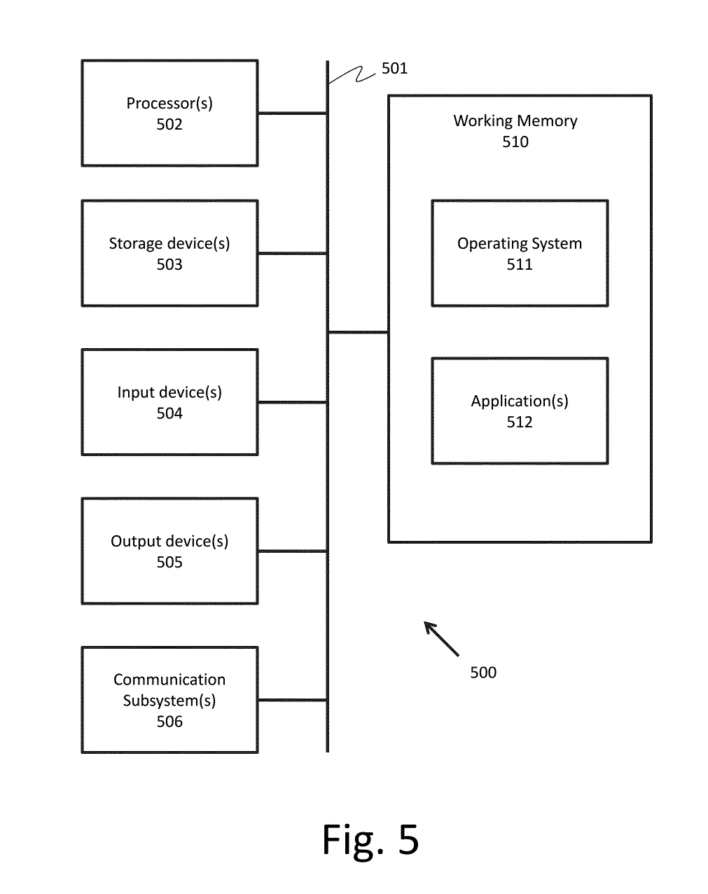

FIG. 1 depicts an arrangement 100 for a preferred embodiment of the present invention. The arrangement comprises a terminal device 101 having a display device 102. The terminal device may be e.g. a mobile terminal and the display device of the terminal may be e.g. a touch-sensitive display. Also other kinds of terminal devices, e.g. personal computers, are applicable. The terminal device 101 is communicatively connected 121, 122 to a server computer 110 via a data communication network 120, e.g. a TCP/IP network. The server computer 110 comprises a data storage 111 adapted to store the data required by the method of an embodiment of the present invention. The data advantageously comprises documents, e.g. invoices that need to undergo an approval process, which for some documents may comprise a manual process. A schematic diagram of the components of a server or terminal computer is shown in more detail in FIG. 5 and discussed in the related detailed description.

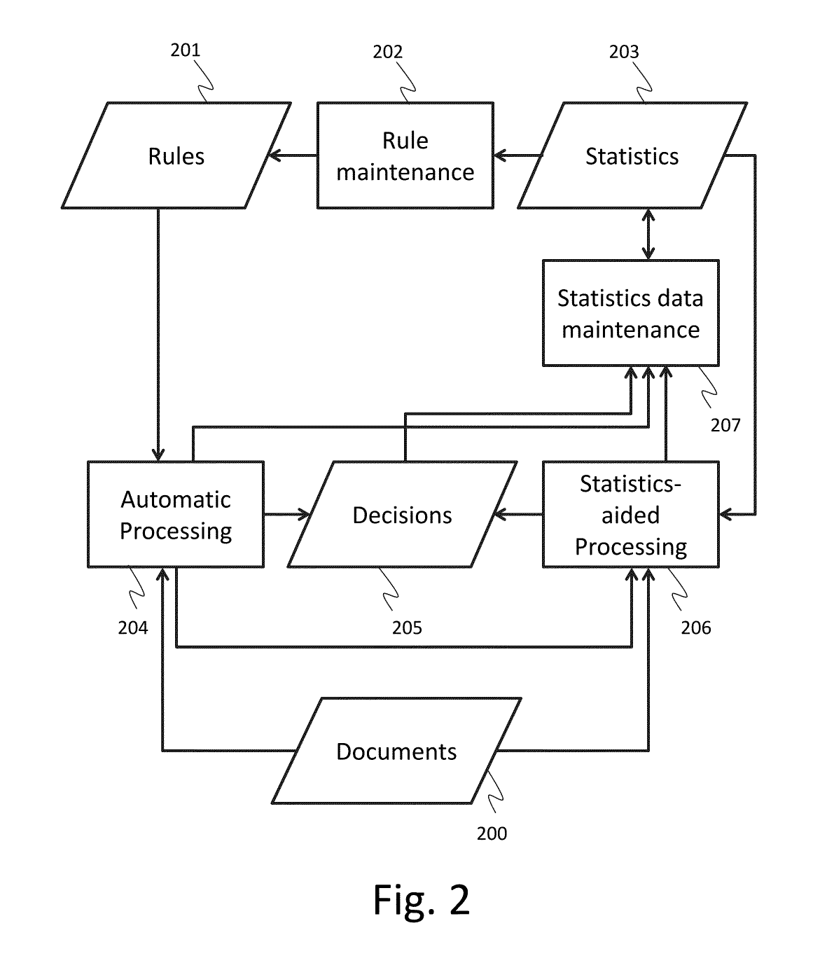

FIG. 2 shows some functional and data components of a preferred computer-implemented embodiment of the present invention. The method is adapted to reach a decision regarding a document 200. The decision may be e.g. approval or rejection of an invoice or a purchase order or a purchase requisition. In a preferred embodiment, the processing is mostly automatic processing 204, which may utilize e.g. rules 201 as a means to reach the decision. The automatic processing is implemented using application program logic (512 in FIG. 5) executable e.g. by the processor (502 in FIG. 5) of the computer 110 (500 in FIG. 5) of the system of an embodiment of the present invention.

The rules 201 are advantageously adapted to reach the decision based on the data of the document and on some additional data associable with the document. The additional data may comprise the calculated component confidence rates of an embodiment of the present invention. For example, a rule may stipulate that an invoice may be approved automatically, if its total amount is less than the amount of a related approved purchase requisition plus some tolerance. An invoice that fails the automatic approval must be approved manually. The rule may be expressed e.g. in pseudo-code e.g. as follows:

```
IF
  invoice.total_amount <= requisition.amount *
  (1+tolerance_percentage)
THEN
  APPROVE
ELSE
  SEND_TO_MANUAL_APPROVAL .
```

Those documents 200, whose decisions cannot be reached automatically, are processed using statistics-aided processing module 206 of the arrangement. The statistics-aided processing module 206 utilizes statistics data 203 in its decision making process which advantageously has at least one step requiring manual input. Both the automatic processing 204 and statistics-aided processing 206 modules produce decisions 205. The decision data 205 may be used to update the statistics data 203 via statistics data maintenance module 207. Both the automatic processing 204 and statistics-aided processing 206 are advantageously adapted to produce new statistics data 203 or update existing statistics data via the statistics data maintenance module 207. In an embodiment, statistics data may be utilized by a rule maintenance module 202, which is adapted to maintain the rules 201 of the automatic processing 204. For example, a sender of an invoice, whose invoices' approval rate in the manual approval process falls below a certain level, may be marked by the statistics data maintenance module of an embodiment of the present invention as a blacklisted sender in the statistics data. Now, the approval rule of the automatic approval process may be amended by the rule maintenance module 202 to use statistics data as follows:

```
IF
  invoice.total_amount <= requisition.amount *
  (1+tolerance_percentage) AND
  invoice.sender NOT IN statistics.blacklist[ ]
THEN
  APPROVE
ELSE
  SEND_TO_MANUAL_APPROVAL .
```

The rule maintenance module is especially useful in embodiments, where the analysis methods performed by the statistics data maintenance module 207 on the statistics data 203 continually evolve and new findings are thus made from the data. Whenever new findings are made that should have effect on the rule-based automatic processing, the rules 201 may be amended by the rule maintenance module 202. In the shown example, such evolution is the introduction of statistics-based blacklist.

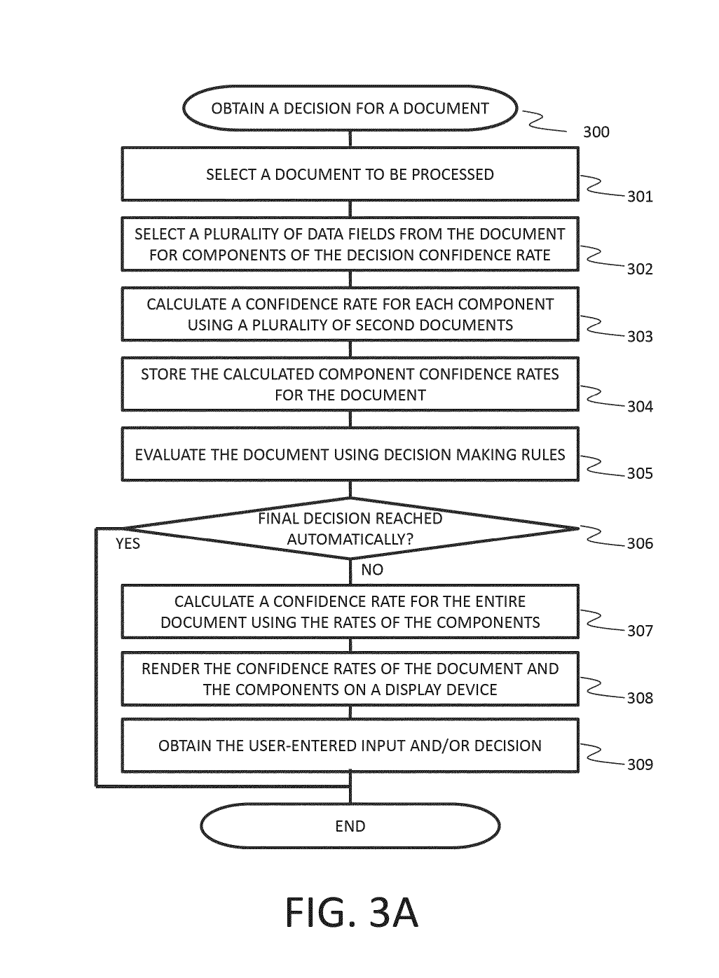

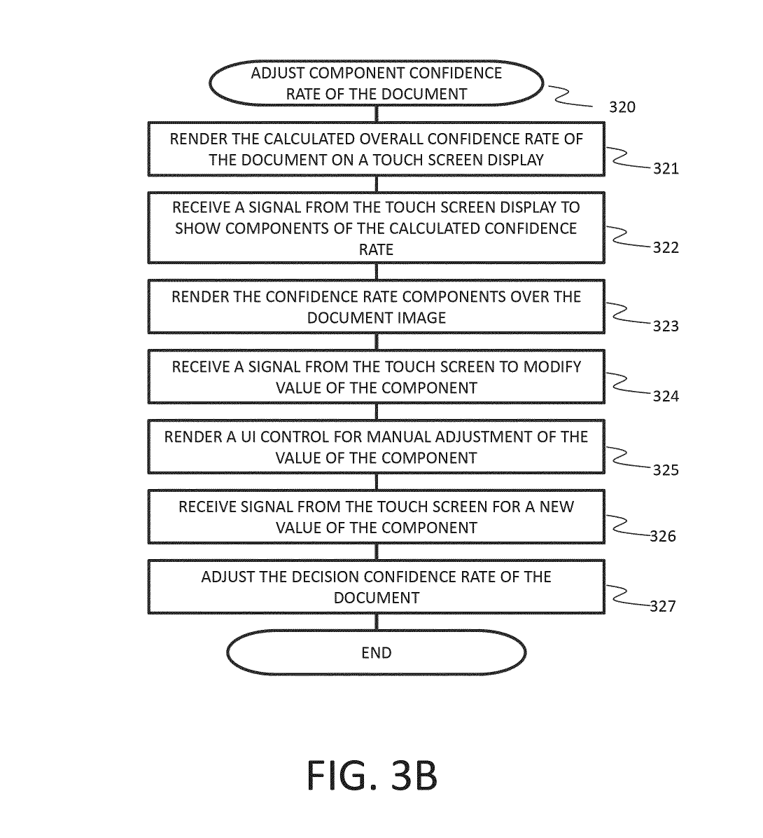

FIG. 3a illustrates the computer executable process 300 of obtaining a statistics-aided decision for a document according to an embodiment of the present invention. The process begins with the step of selecting 301 a document to be processed. This step may comprise reading the data of the document from a storage device 111 into the memory of a computer (e.g. 110 or 101 in FIG. 1). Next, in step 302, the content data of the selected document is analyzed by some computer executable application logic (512 in FIG. 5) to identify and select a plurality of data fields for components of the decision confidence rate of the document. For example, if the document is an invoice, the data fields of a component may comprise e.g. the fields related to the sender (e.g. id, name and address) of the invoice or data fields (e.g. id, name, unit count, unit price, total price) of a single line item of the invoice. Next, at least one confidence rate is calculated for at least one component 303 using the program logic of an application program (512 in FIG. 5). The calculation utilizes data of a plurality of second documents. For example, confidence rate of the sender information of the invoice may be calculated by analyzing a plurality of earlier invoices that has the same or at least partially similar sender information. The analyzed data of the component may comprise the decision data of those documents and/or user input data related to the documents. For example, in case of an invoice document, the approval/rejection information of the invoices may be utilized in the calculation. If all earlier invoices from the sender have been approved, the confidence rate of the sender information may be e.g. 100%. Further, if an invoice from the set of earlier invoices comprises user entered information related to the sender of the invoice, such data may be also taken into account when calculating the confidence rate of the component. For example, as part of the approval process of an earlier invoice, a user may have suggested blacklisting the supplier. Such input may lower significantly the confidence rate of the supplier, i.e. the sender of the invoice. In step 304, the calculated component confidence rates of the document are stored for later possible use. As another example, a confidence rate for a line item may be calculated by an application program (512 in FIG. 5) e.g. by calculating a median value for e.g. unit count and unit price from previous invoices having the same item and calculating deviation of the current document's corresponding data from the median. The bigger the deviation to the upside, the smaller the confidence rate for the item could be. Selecting the suitable exact computer executable algorithm for such calculations is obvious for a person skilled in the art.

In a preferred embodiment, the decision for the document is first attempted to be concluded using at least one decision making rule. The evaluation of the document using the rules is performed in step 305. In an embodiment, the calculated component confidence rates may be utilized by the rules. If the final decision may be reached automatically 306, e.g. an invoice may be automatically approved, the execution of the method ends and the status of the document is set to “Approved”. If, however, automatic decision making fails, the document is assigned to a computer-aided manual decision making process. In step 307, a confidence rate for the entire document is calculated by an application program (512 in FIG. 5) utilizing the component confidence rates in step 303. For example, a suitably weighted average of the component confidence rates may be used as the calculation algorithm. Next, in step 308, the document is rendered, using computer executable instructions, on the display device 102 of terminal device 101 of a user whose task is to manually approve/reject the invoice. In addition to the document data, at least one calculated confidence rate is rendered on the display device by an application program (512 in FIG. 5). In a preferred embodiment, the display device is a touch-sensitive display device arranged to send signals to the computer processor (502 in FIG. 5) upon detection of touches or gestures on the display device. In step 309, a user-entered decision and possibly some other user input is obtained from the user interface. The input data, including the decision data, may be indicated by the user via a touch or gesture of the display device. The display device communicates the decision further to the processor (502 in FIG. 5) which executes suitable instructions of an application program (512 in FIG. 5) utilizing services of the operating system (511 in FIG. 5). The application program may also take some further actions, e.g. by storing the decision data and optionally some other user input data into the persistent memory of the system, e.g. into the data storage 111 (503 in FIG. 5). In a preferred embodiment, the stored data is utilized in the processing of future documents and/or in the maintenance work of the decision making rules of the system.

FIG. 3b shows in greater detail the method of obtaining user input of step 309, e.g. adjusting 320 a component confidence rate of the document, usable in a preferred embodiment of the present invention. In step 321, the overall confidence rate of the document is calculated and rendered on a touch screen display by a computer executed application program (512 in FIG. 5). The overall (document level) confidence rate may be e.g. a percentage rate between 0-100 or it may be a binary recommendation value (e.g. “approve” vs. “reject”) or a value from any other suitable scale. In step 322, the processor (501 in FIG. 5) of the terminal computer 101 (500 in FIG. 5) receives a signal from the touch screen display 102 (504 and 505 in FIG. 5). The signal indicates a request to show components of the calculated confidence rate. In step 323, the application logic (512 in FIG. 5) instructs the display device to render at least one component confidence rate on the display device, preferably as an overlay of the document image. Next the touch screen device detects a touch which indicates a request to modify value of a component confidence rate. In a preferred embodiment, the processor executing the application logic receives a signal 324 which is translated by the instructions of the application program (512 in FIG. 5) into the modification request. In response to the request, the application program instructs the processor to render a UI control for manual adjustment of the value of the component confidence rate 325. Once the control has been rendered, the user may touch the rendered control which makes the display device to send a signal to the processor 326. The signal is then translated into an instruction to adjust the component confidence rate of the document 327.

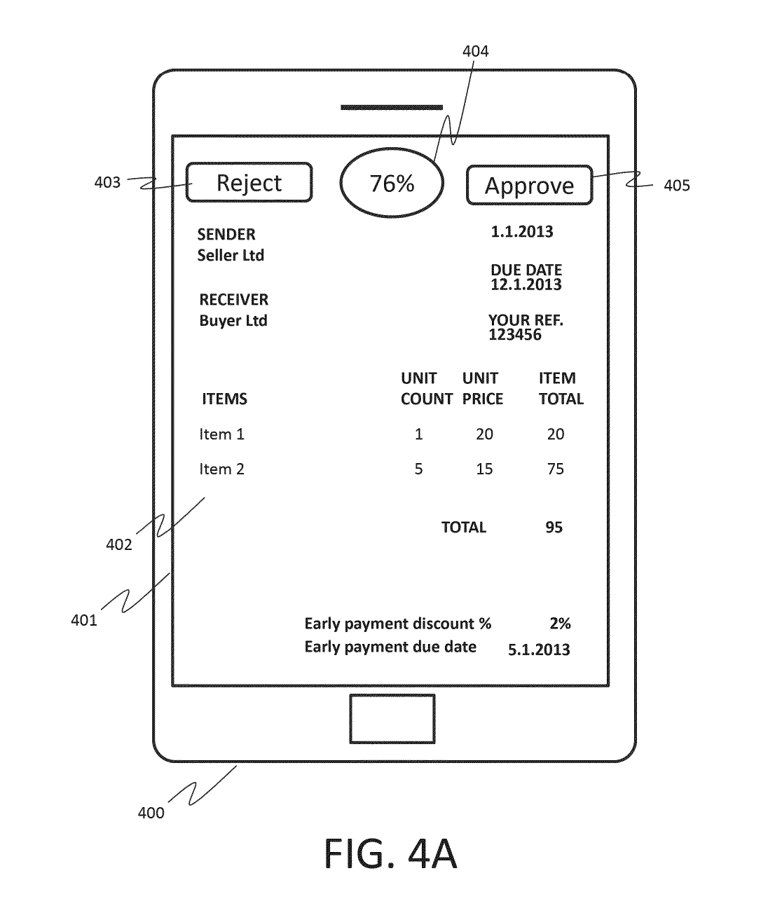

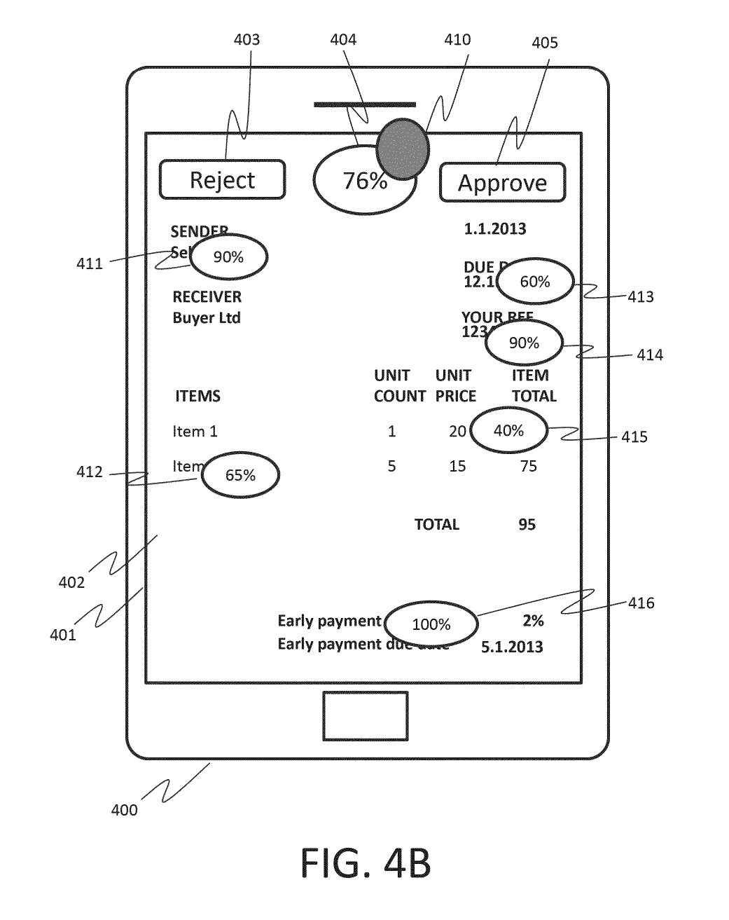

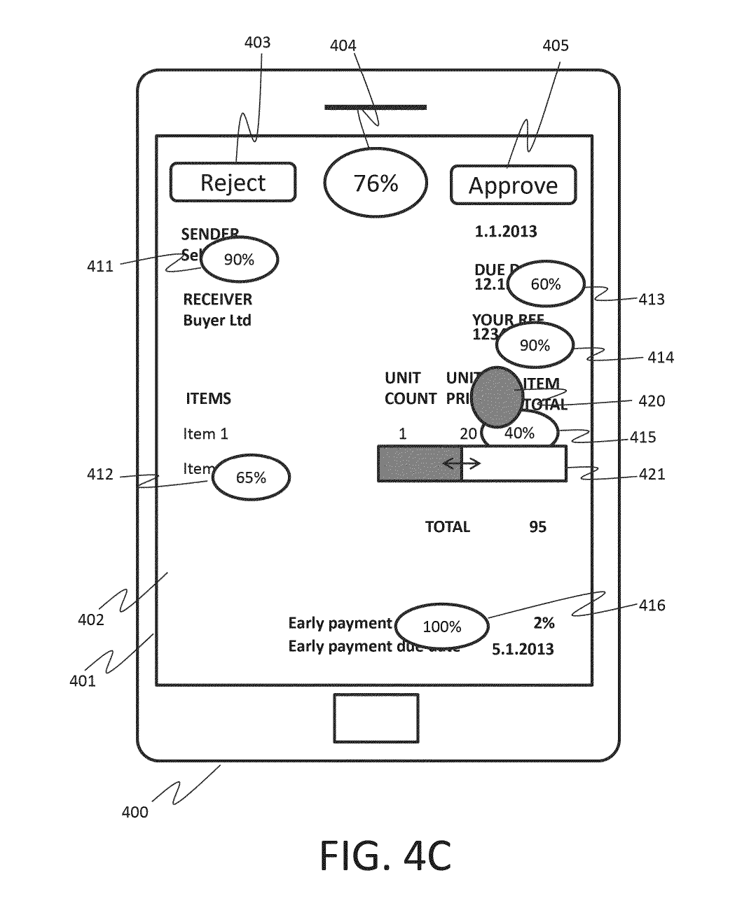

FIG. 4a shows an exemplary implementation of a user interface for statistics-aided processing of a document. The terminal device 400 (101 in FIG. 1, 500 in FIG. 5) comprises a display device, which in a preferred embodiment is a touch-sensitive device and is thus capable of acting both as an input and an output device (504 and 505 in FIG. 5). The display device 401 is adapted to display a document 402. In a preferred embodiment of the present invention, the display device is also adapted to display an area that indicates a first decision alternative, e.g. document rejection 403, and a second decision alternative, e.g. document approval 405, as well as a statistical document-level confidence rate 404 for the second decision alternative.

FIG. 4b depicts the example of FIG. 4a after the user of the terminal device 400 has touched 410 the area illustrating the statistical confidence rate 404. In the shown embodiment, the confidence rate of the entire document is split into components 411-416. The components characterize the calculated confidence level of components of the invoice to recommend the second decision alternative, e.g. document approval 405. In the exemplary case of an invoice, the confidence level of a component may be calculated e.g. for the sender 411, due date 413, reference number 414, unit price of the line item 415, the product/service of the line item 412 or additional payment terms (e.g. dynamic discounting) 416. To calculate the component level confidence rates, any suitable algorithm may be used. The algorithm may vary from one component to another. In a preferred embodiment, the component confidence rate is calculated using the data of the shown document and the data of a plurality of second documents. The decision data associable with the documents may also be used in the calculation. For example, the confidence rate of the sender component 411 may be calculated from the approval rate of the invoices received earlier from the same sender. E.g. 90% confidence may indicate, that 90% of the invoices received from the sender have been approved without disputes.

In a preferred embodiment, the confidence rate of a component of the document may be manually adjusted by the user making the approval/rejection decision. FIG. 4c shows an example, where user touches 420 the component confidence rate 415 of the unit price line item of an invoice line item. The calculated confidence rate in the shown example is 40%, which may e.g. indicate to the user, that the item unit price has significantly risen recently (i.e. the current unit price deviates significantly from the mean unit prices of the same item of the previous invoices). For that reason, the attention of the users is drawn to the component. Now the user may use the user interface control 421 rendered by the application program (512 in FIG. 5) to manually adjust the confidence rate higher or lower from the value calculated by the algorithm of the application program (512 in FIG. 5). For example, the user may set the confidence rate 415 to zero and touch the “Reject” button 403 rendered on the screen. This indicates, that the new unit price was not acceptable to the receiver of the invoice and that some additional action should be taken, e.g. the invoice should be disputed because of the sudden rise of the unit price. Alternatively, the user may adjust the confidence rate 415 higher and touch the “Approve” button 405. This indicates that the price increase is an acceptable one and the new price is the new approved price for the product/service of the line item. The user's input may be utilized in subsequent invoices having the same line item. For example, the calculated confidence rate of the component may remain at the user-defined level until the invoices have been approved or the unit price has been corrected. This way, component-level information about potential issues in the documents may be conveniently communicated within the organization utilizing the decision-making process related to the documents.

FIG. 5 shows a schematic illustration of one embodiment of a computer system, e.g. a server computer or a terminal computer that can perform the methods of the embodiments described herein. It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown comprising hardware elements that can be electrically coupled via a bus 501 (or may otherwise be in communication, as appropriate). The hardware elements can include one or more processors 502, communication subsystems 506, e.g. network connection equipment, one or more input devices 504, which can include without limitation a touch-sensitive device, mouse, a keyboard and/or the like; and one or more output devices 505, which can include without limitation a display device, a printer and/or the like. The computer system 500 may further include (and/or be in communication with) one or more storage devices 503. The computer system 500 also may comprise software elements, shown as being located within the working memory 510, including an operating system 511 and/or other code, such as one or more application programs 512, which may comprise computer programs of the described embodiments, and/or may be designed to implement methods of the described embodiments of a computer-method of the embodiments as described herein.

At least some embodiments include a program storage device readable by a machine, tangibly embodying a program of instructions executable by the machine to perform a computer-method of an embodiment of the present invention.

Although specific embodiments have been described and illustrated, the embodiments are not to be limited to the specific forms or arrangements of parts so described and illustrated.

1. A computer executable method for facilitating a decision making process for a first document comprising a plurality of data components, each data component comprising at least one data field, wherein the method comprises computer executed steps of:
a. identifying from the first document at least one data component for which a confidence rate is calculateable,
b. for each identified data component, selecting a plurality of second documents that are associable with the first document based at least in part on the data content of the identified data component of the first document,
c. for each identified data component of the first document, calculating a confidence rate utilizing the data of the plurality of second documents, and
d. initiating a decision making process for the first document wherein the process utilizes at least one of the calculated confidence rates.

2. A method according to claim 1, wherein the method further comprises calculating a decision confidence rate for the entire document.

3. A method according to claim 2, wherein the step of initiating the decision making process comprises rendering the calculated decision confidence rate of the entire document on the display device of a terminal computer.

4. A method according to claim 2, wherein the step of initiating the decision making process comprises executing an automatic decision for the document based on the value of the at least one calculated decision confidence rate.

5. A method according to claim 3, wherein the method further comprises the step of rendering at least one of the calculated component confidence rates on the display device of the terminal computer.

6. A method according to claim 5, wherein the method further comprises the step of rendering at least one user interface control on the display device of the terminal computer for the purpose of receiving at least one user input event regarding at least one component confidence rate of the document.

7. A method according to claim 6, wherein the display device is a touch sensitive display device.

8. A method according to claim 6, wherein the method further comprises step of storing in the memory of the computer the at least one user input event related to at least one calculated component confidence rate of the document.

9. A method according to claim 8, wherein the user input event comprises a new value for the component confidence rate.

10. A method according to claim 1, wherein the method further comprises the step of storing the reached decision regarding the document and creating or updating, based on the decision and the content data of at least one document, at least one rule to automate the decision making process for future documents.
